(19) United States
(12) Patent Application Publication
(10) Pub. No.: US 2015/0296753 A1
(43) Pub. Date: Oct. 22, 2015

(54) FLOATING ASSEMBLY USING CONTAINERS

(71) Applicants: Heung Mook KANG, Seoul (KR); Yong Mook KANG, Seoul (KR)

(72) Inventors: Heung Mook KANG, Seoul (KR); Yong Mook KANG, Seoul (KR)

(21) Appl. No.: 14/650,435

(22) PCT Filed: Dec. 5, 2013
(86) PCT No.: PCT/KR2013/011222

§ 371 Date: Jun. 8, 2015

(30) Foreign Application Priority Data
Dec. 7, 2012 (KR) 10-2012-0142245

(51) Int. Cl. A01K 61/00; B63B 35/44; B63B 45/04; B63B 22/20

(52) U.S. Cl. CPC A01K 61/007; B63B 22/20; B63B 35/44; B63B 45/04; B63B 2213/02

(57) ABSTRACT

Provided is a floating assembly. The floating assembly of the present invention comprises a plurality of containers having buoyancy by the air which fills the internal spaces of the containers by means of injection ports formed in one end of each container, an injection port lid which has a check valve for supplying air in one direction into the inside of the container, wherein the check valve arranged at the bottom surface of a lid member is coupled to the injection port, and which seals the injection port, and a container fixing unit having a plurality of fixing holes for the insertion and fixation of the containers, wherein the container fixing unit fixes the plurality of containers arranged in the vicinity of each other.

### TECHNICAL FIELD

The present invention relates to a floating assembly. More particularly, the present invention relates to a floating assembly, in which a plurality of recyclable containers, such as polyethylene terephthalate (PET) bottles, is connected together, and the ambient air is supplied to the plurality of recyclable containers, whereby the floating assembly is buoyant and can float on the surface of the water.

### BACKGROUND ART

In general, floating structures, such as a buoy, are used as means for constructing or indicating a fish farm. Specifically, a farming structure, such as a net or a rope, is hung on cylindrical floating structures such that the farming structure floats in the sea. Floating structures are used in some fields of the marine products industry in which adhesion organisms, such as laver, brown seaweed, or oysters, are raised in seawater.

Floating structures are generally manufactured from a polystyrene foam (hereinafter referred to as a “Styrofoam”) or a polyethylene foam resin material. In particular, floating structures formed of a Styrofoam material are most commonly used at present due to the advantages thereof, such as light weight, strong buoyancy, corrosion resistance, cheap manufacturing costs, and the ease of construction works.

In addition, it is known that floating structures are divided into a structure, the central portion of which is hollow in order to maximize buoyancy, and a structure that is integrally manufactured such that the central portion thereof is solid in order to enhance strength.

However, a floating assembly formed of Styrofoam floating structures has weak tensile strength and tends to be damaged when the floating assembly is subjected to impacts from waves or wind or collides against a variety of floating objects. Since the Styrofoam material has a number of large pores, when the floating assembly has been used for about one year in seawater, the buoyancy thereof decreases due to the aggregation of seawater and the floating assembly fails to properly act. In addition, Styrofoam fragments resulting from fractured Styrofoam buoys contaminate a nearby sea area while floating in the sea.

In addition, the volume of a floating assembly of the related art increases in proportion to the amount of buoyancy. A floating assembly having a large amount of buoyancy has a large volume, and it is difficult to transport to the large floating assembly to an installation location.

In addition, the use of Styrofoam floating structures is restricted since Styrofoam floating structures contaminate the environment by, for example, blanketing the seabed from sunlight, thereby obstructing the photosynthesis of animals and plants growing on the seabed. However, Styrofoam floating structures are still used at present due to the inexpensiveness thereof and the absence of substitute products.

For this, Korean Patent Application Publication No. 2001-0035054 (May 7, 2001) and Korean Patent Application Publication No. 2006-0097520 (Sep. 14, 2006) disclosed a floating assembly manufactured through cross-linked foam injection of a resin or using liquefied wood polyurethane.

However, in the floating assembly of the related art, floating structures must be manufactured separately, the ability to reduce manufacturing costs is limited.

### DISCLOSURE

### Technical Problem

The present invention has been made keeping in mind the above problems occurring in the related art, and the present invention is intended to provide an environmentally-friendly floating assembly able to reduce manufacturing costs by recycling disposable containers and be easily transported by reducing the volume thereof by deforming containers formed of a plastic material.

### Technical Solution

According to an aspect of the present invention, a floating assembly includes: a plurality of containers, each of the plurality of containers being buoyant due to air contained in an inner space thereof through an inlet in one end thereof; a plurality of inlet stoppers, each of the plurality of inlet stoppers sealing the inlet of a corresponding container of the plurality of containers using a check valve in a bottom of a stopper member that couples with the inlet, the check valve supplying air in a predetermined direction, thereby sealing the inlet; and a container fixing part having a plurality of fixing holes into which the plurality of containers is fitted such that the plurality of containers is fixed in position, whereby the plurality of containers adjacent to each other is fixed.

It is preferable that the check valve include a valve body extending a predetermined length, the valve body having an input line through which the air is blown in, an input terminal of the input line being exposed on an outer surface of the stopper member, and a hollow elastic body fitted into the valve body, the hollow elastic body covering a nozzle terminal of the input line exposed on an outer surface of the valve body.

It is preferable that the input line include at least one linear hole penetrating in a longitudinal direction of the valve body.

It is preferable that the valve body include at least one protruding rim protruding from the outer surface of the valve body.

It is preferable that the hollow elastic body be fixed in position by a fixing ring that elastically adjoins an outer surface of the hollow elastic body.

It is preferable that the container fixing part include a fixing member in which the plurality of fixing holes is formed. The plurality of containers are fixedly fitted into the plurality of fixing holes in a corresponding manner.

It is more preferable that the fixing member include a coupling recess coupling with a coupling protrusion protruding from an outer surface of an adjacent fixing member in a corresponding manner and a coupling protrusion coupling with a coupling recess depressed in an outer surface of an adjacent fixing member in a corresponding manner.

It is more preferable that the fixing member have weight-reducing through-holes each formed between adjacent fixing holes of the plurality of fixing holes.

It is preferable that each of the fixing holes have a close-contact protrusion protruding from an inner surface thereof, the close-contact protrusion adjoining an outer surface of a corresponding container of the plurality of containers.

It is preferable that the fixing member include an upper fixing plate having a plurality of upper fixing holes, a lower fixing plate having a plurality of lower fixing holes formed in areas corresponding to the upper fixing holes in a penetrating manner, and a connecting fixing plate connecting an outer circumference of the upper fixing plate and an outer circumference of the lower fixing plate to each other

It is preferable that the container fixing part include an upper ring support having a plurality of circular or polygonal upper fixing rings, a lower ring support having a plurality of lower fixing rings in a plurality of areas corresponding to the plurality of upper fixing rings, and a connecting part connecting the upper and lower ring supports

It is preferable that the floating assembly further include an inlet-fixing connecting part into which predetermined end portions of the plurality of containers are fitted, the inlet-fixing connecting part including a lower fixing member, with a plurality of fixing recesses being depressed to a predetermined depth in an upper surface of the lower fixing member such that outer surfaces of bodies of the plurality of containers having the inlets are fitted into and fixed by the fixing recesses, inlet stoppers disposed on bottoms of the fixing recesses such that the inlet stoppers are connected to the inlets.

It is more preferable that each of the fixing recesses have at least one close-contact protrusion protruding from an inner surface thereof, the close-contact protrusion adjoining an outer surface of a corresponding container of the plurality of containers.

It is more preferable that the lower fixing member have a coupling recess coupling with a coupling protrusion protruding from an outer surface of an adjacent lower fixing member in a corresponding manner and a coupling protrusion coupling with a coupling recess depressed in an outer surface of an adjacent fixing member in a corresponding manner.

It is more preferable that fixing member have weight-reducing through-holes each formed between adjacent fixing holes of the plurality of fixing holes.

It is more preferable that the inlet stoppers be disposed integrally on closed bottoms of the fixing recesses or are assembled to the stopper assembly holes in a corresponding manner, the stopper assembly holes penetrating through the closed bottoms of the fixing recesses.

It is preferable that each of the plurality of containers include a first cover having an open end portion corresponding to the inlet and a closed end portion opposite the open end portion, the container being fitted into the first cover through the open end portion such that an outer surface of the container comes into close contact with an inner surface of the first cover.

It is preferable that each of the plurality of containers include a second cover, wherein a cover inlet formed in one end portion of the second cover corresponding to the inlet is opened and closed by a stopper, and the other end portion of the second cover corresponding to a closed end of the container is cut open, the container being fitted into the second cover such that an outer surface of the container comes into close contact with an inner surface of the second cover.

It is preferable that each of the plurality of containers includes an expansion member having an entrance end connected to the inlet stopper, wherein, when air is blown in, a volume of the expansion member expands such that an outer surface of the expansion member comes into close contact with an inner surface of the container.

It is preferable that each of the plurality of containers include a fluorescent material supplied into an inner space thereof together with air, a fluorescent material applied on an inner or outer surface thereof, a location tracking device based on a global positioning system, or at least one light source disposed within the inner surface thereof.

### Advantageous Effects

The present invention has the following effects:

(1) A floating structure can be constructed by fixing the hollow containers, such as disposable waste plastic containers, into the fixing holes of the fixing member and blowing the air into the containers through the stopper inlets assembled to the inlets of the containers. The floating structure can be used for a variety of purposes while floating in the sea. The present invention can save resources by recycling waste containers, is environmentally friendly, and can reduce manufacturing costs.

(2) The containers formed of a plastic material can be deformed in order to reduce the volume thereof before being transported. After the transportation, the containers are restored to the original shape in order to create buoyancy. It is therefore possible to reduce the burden associated with the transportation of materials required for the construction of the floating assembly.

(3) It is possible to reduce manufacturing costs by reducing the weight of the fixing member to which the containers are fixed while increasing the lifespan of the containers by providing the covers in close contact with the outer surfaces of the containers fixed to the fixing member.

### DESCRIPTION OF DRAWINGS

FIG. 1 is an overall configuration view illustrating a floating assembly according to an exemplary embodiment of the present invention;

FIG. 2a to FIG. 2e illustrate an inlet stopper employed in the floating assembly according to the exemplary embodiment of the present invention, in which

FIG. 2a is a perspective view,

FIG. 2b is an assembled cross-sectional view,

FIG. 2c is cross-sectional view illustrating the coupling between the inlet stopper and the container,

FIG. 2d illustrates an alternative embodiment of the inlet stopper, and

FIG. 2e illustrates another alternative embodiment of the inlet stopper;

FIG. 3a to FIG. 3d are configuration views illustrating a variety of embodiments of a container-holding part employed in the floating assembly according to the exemplary embodiment of the present invention;

FIG. 4 is a perspective view illustrating an inlet-fixing connecting part employed in the floating assembly according to the exemplary embodiment of the present invention;

FIG. 5a and FIG. 5b are configuration views illustrating a variety of embodiments of the inlet-fixing connecting part employed in the floating assembly according to the exemplary embodiment of the present invention;

FIG. 6a and FIG. 6b are configuration views illustrating an embodiment of a first cover employed in the floating assembly according to the exemplary embodiment of the present invention;

FIG. 7a and FIG. 7b are configuration views illustrating an embodiment of a second cover employed in the floating assembly according to the exemplary embodiment of the present invention; and

FIG. 8 is a configuration view illustrating an embodiment of an expansion member employed in the floating assembly according to the exemplary embodiment of the present invention.

### BEST MODE

The above and other objects, features, and advantages of the present invention will be more clearly understood from the following detailed description. Reference will now be made in greater detail to exemplary embodiments of the present invention in conjunction with the accompanying drawings.

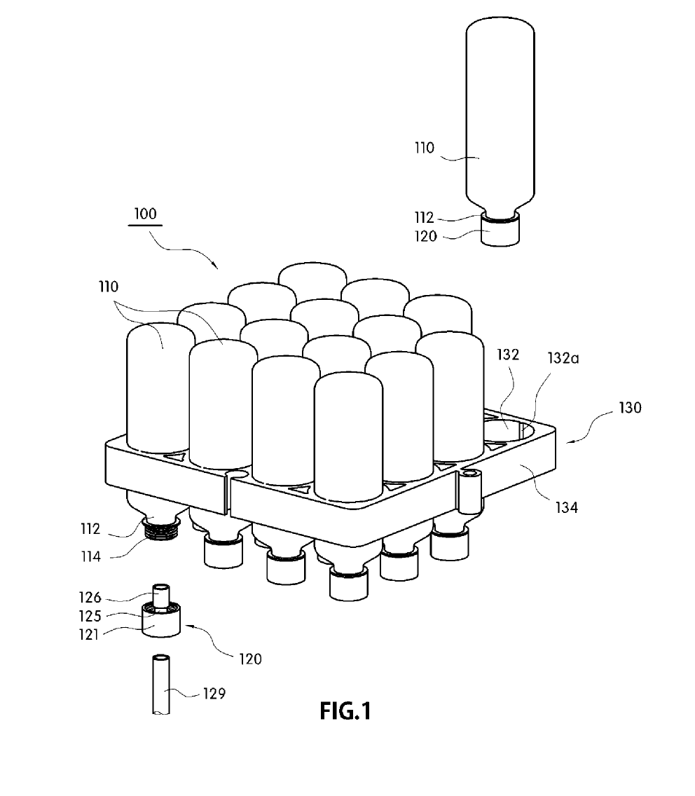

As illustrated in FIG. 1 to FIG. 3d, a floating assembly 100 according to an exemplary embodiment of the present invention includes containers 110, inlet stoppers 120, and a container fixing part 130.

Each of the containers 110 may be implemented as a container formed of a plastic material. The container 110 has an inlet 112 at one end thereof, through which a fluid, such as air, is supplied from an external source. The inner space of the container having a predetermined size is filled with the air, thereby creating buoyancy by which the container can float on the surface of the water.

The container 110 may be selectively implemented as a container configured such that the outer diameter of the entrance side is smaller and the outer diameter of the remaining body part is greater. The entrance side is the inlet through which the air is supplied, and the body part defines therein the inner space that is filled with the blown-in air that is.

Here, a disposable plastic container may be used without processing as the container 110 that becomes buoyant when the air is contained.

Each of the inlet stoppers 120 serves to guide the ambient air into the inner space of the container 110, and couples with the container 110 to seal the inlet 112 of the container filled with the air.

The inlet stopper 120 includes a stopper member 121 that couples with the inlet 112 in a corresponding manner and a check valve 123 extending from the bottom of the stopper member 121 to supply the air from an external source in one direction. The inlet stopper 120 can perform both an air blowing function and a sealing function.

Specifically, the stopper member 121 has female threads 122 formed on the inner circumference. The female threads 122 are configured to couple with male threads 114 formed on the outer circumference of the inlet 112. The check valve 123 extends to a predetermined height from the bottom of the stopper member 121, and is connected to an air supply line 129 of an air supply pump (not shown). The check valve 123 supplies the air in one direction such that the air fills up the inner space of the container 110 when the inlet 112 is coupled with the stopper member 121.

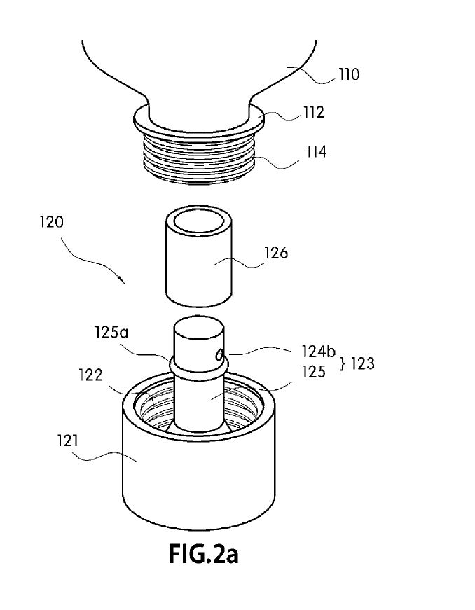

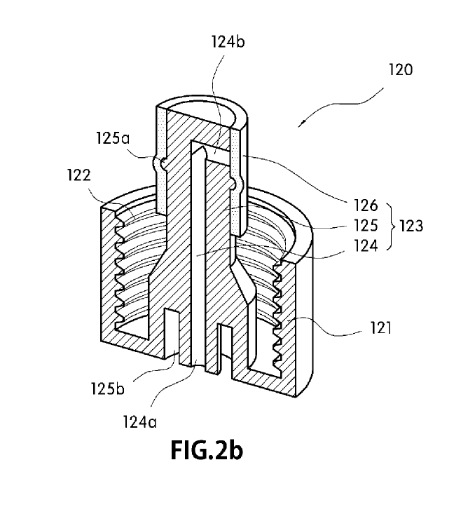

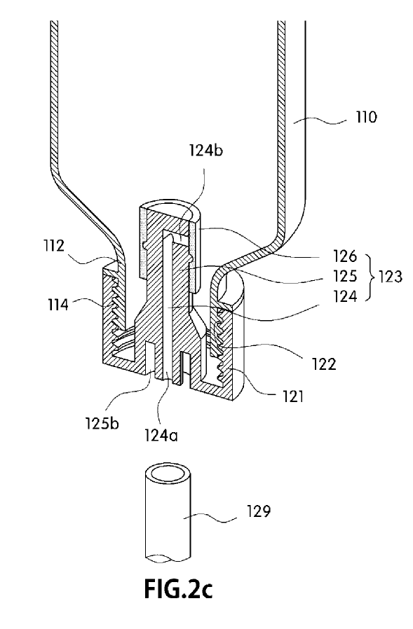

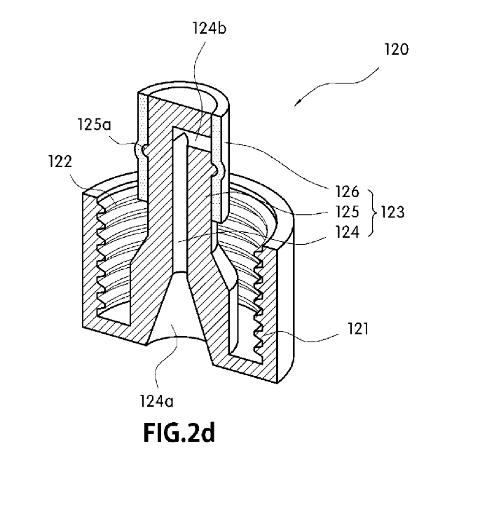

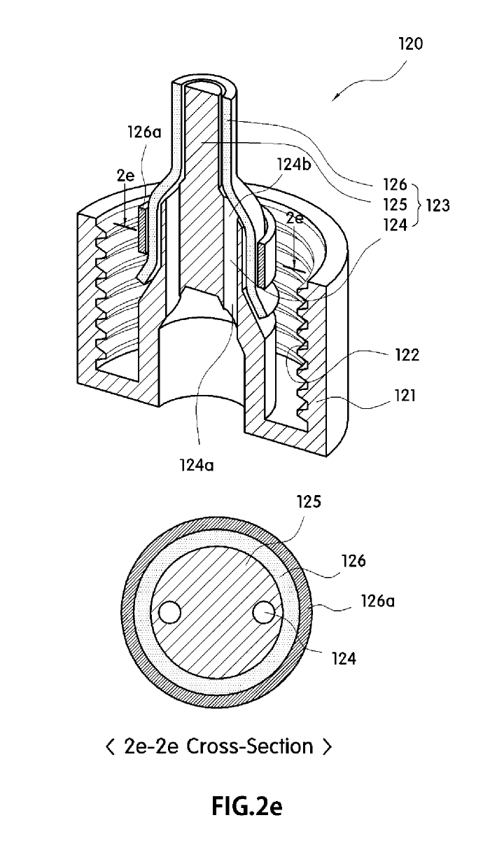

As illustrated in FIG. 2a to FIG. 2c, the check valve 123 includes a valve body 125 extending a predetermined length and a hollow elastic body 126 fitted into the valve body 125. The valve body 125 has an input line 124 through which the air is blown in. An input terminal 124a of the input line 124 is exposed on the outer surface, i.e. the bottom surface, of the stopper member 121. The hollow elastic body 126 covers a nozzle terminal 124b of the input line 124 that is exposed on the outer surface of the valve body.

Here, the valve body 125 is formed of the same material as the stopper member 121, and is in the shape of a cylinder extending a predetermined height from the bottom. It is preferable that the hollow elastic body 126 is implemented as a hollow pipe formed of an elastic material, such as rubber or resin, such that the hollow elastic body 126 elastically covers the nozzle terminal of the input line 124 exposed on the outer surface of the valve body.

With this configuration, after the input line 124 having the input terminal 124a exposed on the outer surface of the stopper member 121 is connected to the air supply line 129 of the air supply pump, when the air is forcibly supplied through the input line 124, the hollow elastic body 126 fitted into the outer surface of the valve body 125 to cover the nozzle terminal 124b of the input line 124 is partially raised by the pressure of the forcibly-supplied air, opening the nozzle terminal exposed on the outer surface of the valve body 125, so that the air is discharged through the opened nozzle terminal. In this manner, the air can be blown into and fill the inner space of the container 110.

In addition, when the blowing of the air through the input line 124 is stopped, the elastic restoring force of the hollow elastic body 126 restores the nozzle terminal 124b of the input line to the covered initial position, thereby sealing the nozzle terminal 124b. This can consequently prevent the air in the container 110 from flowing backward.

Here, it is preferable that the valve body 125 has at least one protruding rim 125a protruding from the outer surface thereof corresponding to the hollow elastic body in order to prevent the hollow elastic body 126, which is fitted to cover the nozzle terminal 124b of the input line 124, from being dislodged from the valve body.

In addition, the stopper member 121 will be illustrated and described as having an annular assembly recess 125b depressed in one surface thereof on which the input terminal 124a of the input line 124 is exposed. However, this is not intended to be limiting, and the input terminal 124a of the input line 124 may protrude outward a predetermined length from one surface of the stopper member to be connected to the air supply line 129.

As illustrated in FIG. 2d, the cross-section of the input terminal 124a formed in the input line 124 of the inlet stopper 120 may be configured such that the inner diameter thereof increases outward.

In the inlet stopper 120, as illustrated in FIG. 2d, the input line 124 having the input terminal 124a, through which the air is blown in, and the nozzle terminal 124b, which the hollow elastic body 126 covers, may be configured as at least one linear hole penetrating in the longitudinal direction of the valve body 125.

The hollow elastic body 126 may be fixed in position by a fixing ring 126a that elastically adjoins the outer surface thereof such that the hollow elastic body 126 is not easily dislodged from the valve body 125, or may be fixed in position by at least one protruding rim protruding from the outer surface of the valve body.

The cross-section of the valve body 125 is configured such that the outer diameter of the lower body is greater than the outer diameter of the upper body. Although the nozzle terminal 124b of the input line 124 has been illustrated and described as being exposed to the outside at the boundary between the upper and lower body parts having different outer diameter sizes, the cross-section of the nozzle terminal may be configured such that the outer diameter thereof gradually increases in the direction of the inlet terminal.

The container fixing part 130 has a plurality of fixing holes 132 into which the plurality of containers 110 with the plurality of inlet stoppers 120 being connected thereto is fitted such that the plurality of containers 110 is fixed in position. With this configuration, the plurality of containers adjacent to each other is simultaneously fixed in position.

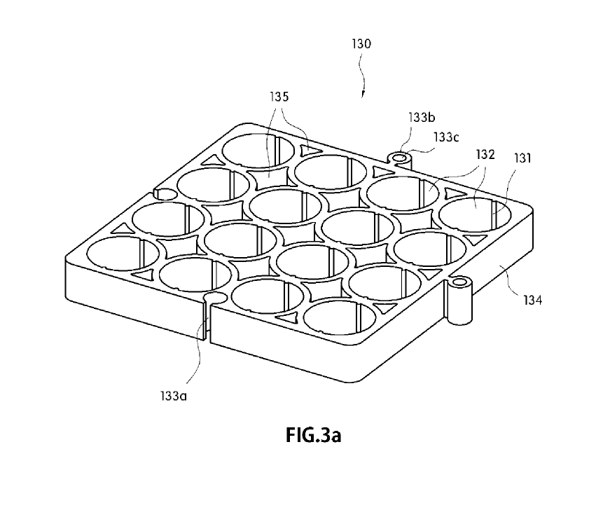

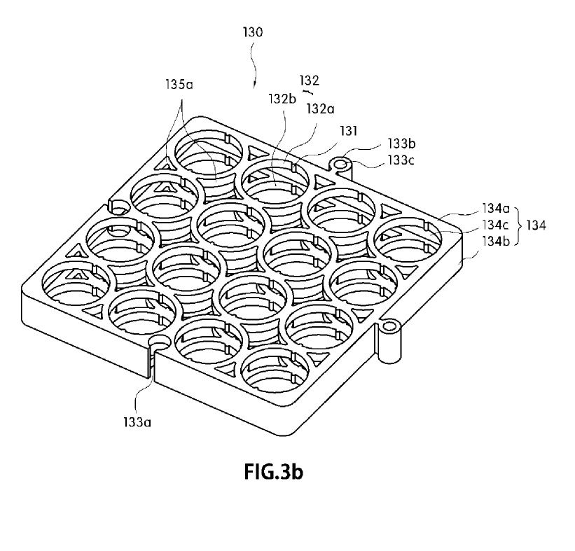

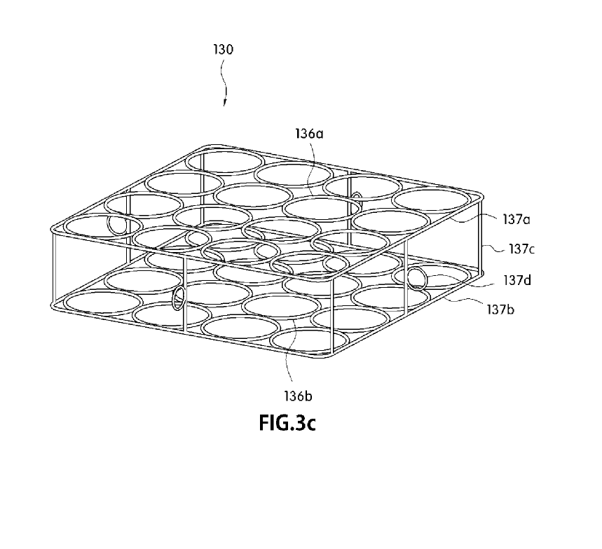

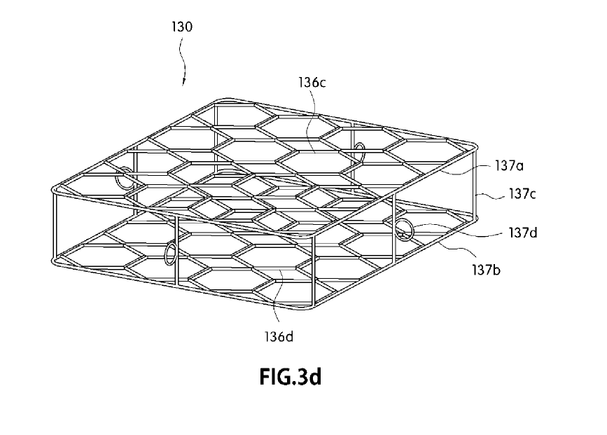

As illustrated in FIG. 3a, the container fixing part 130 includes a fixing member 134 in which the plurality of fixing holes 132 is formed in a penetrating manner. The bodies of the plurality of containers 110 are fixedly fitted into the plurality of fixing holes 132 in a corresponding manner. The fixing member 134 may be formed of a resin material produced by injecting or extruding a resin, such as plastic, may be formed by binding a band-shaped material, or may be formed by weaving a net-shaped structure.

Here, at least one close-contact protrusion 131 is provided on the inner surface of each of the fixing holes 132 that comes into surface contact with the outer surface of the corresponding container 110 fitted thereinto. The close-contact protrusion 131 protrudes from the inner surface of the fixing hole 132 in order to increase fixing force through the increased close contact between the container 110 and the fixing hole 132.

A coupling recess 133a and a coupling protrusion 133b are formed on the outer surface of the fixing member 134. The coupling recess 133a couples with a coupling protrusion protruding from the outer surface of an adjacent fixing member 134 in a corresponding manner. The coupling protrusion 133b couples with a coupling recess depressed in the outer surface of an adjacent fixing member 134 in a corresponding manner. A connecting hole 133c penetrates through the coupling protrusion 133b such that a connecting member, such as a wire or a connecting cord, having a predetermined length can be connected thereto. However, this is not intended to be limiting, and a separate fixing device may be used to connect and couple the adjacent fixing members to each other.

In addition, the fixing member 134 may have weight-reducing through-holes 135 formed between the adjacent fixing holes 132. The weight of the fixing member 134 formed of a resin material can be reduced by the amount equal to the volume of the weight-reducing through-holes 135. In addition, the amount of the resin material used can be reduced, thereby reducing manufacturing costs.

With this configuration, a plurality of the adjacent fixing member 134 can be assembled to a unitary body by the coupling between the coupling recess 133a and the coupling protrusion 133b.

As illustrated in FIG. 3B, the fixing member of the container fixing part 130 includes an upper fixing plate 134a, a lower fixing plate 134b, and a connecting fixing plate 134c. The upper fixing plate 134a has a plurality of upper fixing holes 132a. The lower fixing plate 134b has a plurality of lower fixing holes 132b perforated in areas corresponding to the upper fixing holes 132a. The connecting fixing plate 134c connects the outer circumference of the upper fixing plate 134a and the outer circumference of the lower fixing plate 134b.

It is preferable that also the upper and lower fixing plates 134a and 134b be provided with weight-reducing through-holes 135a between the adjacent upper and lower fixing holes 132a and 132b in order to reduce the weight of the upper and lower fixing plates 134a and 134b and the amount of the material used.

In the fixing member 134 including the upper and lower fixing plates 134a and 134b and the connecting fixing plate 134c, the fixing holes 132 are formed of the matching upper and lower fixing holes 132a and 132b. The containers 110 to be filled with the air can be fitted into and fixed in position by the corresponding fixing holes 132.

In addition, open areas are defined between the upper and lower fixing plates 134a and 134b such that the outer surfaces of the containers are exposed through the open areas. This configuration can reduce the weight of the fixing member 134 by the amount equal to the volume of the opening areas and reduce the amount of the material used, thereby reducing manufacturing costs.

As illustrated in FIG. 3C and FIG. 3D, the container fixing part 130 includes an upper ring support 137a, a lower ring support 137b, and a connecting part 137c. The upper ring support 137a includes a plurality of circular or polygonal upper fixing rings 136a. The lower ring support 137b includes a plurality of lower fixing rings 137b in a plurality of areas corresponding to the plurality of upper fixing rings 136a. The connecting part 137c connects the upper and lower ring supports 137a and 137b. With this configuration, hollow containers 110, i.e. objects to be fixed, having a circular or polygonal cross-section can be fitted into the container fixing part 130 in the top-to-bottom direction, and the container fixing part 130 can fix the containers 110.

Here, the upper and lower ring supports 137a and 137b and the plurality of upper and lower fixing rings 136a and 136b thereof can be formed of one material selected from among a resin, such as plastic, metal wires, and net ropes. It is preferable that the adjacent fixing rings be connected to each other and the outer fixing rings be integrally connected or bound to the upper and lower ring supports 137a and 137b, thereby forming an integral structure.

In addition, a connecting hook 137d is formed on the connecting part 137c. A connecting member, such as a wire or a connecting cord, having a predetermined length can be connected to the connecting hook 137d.

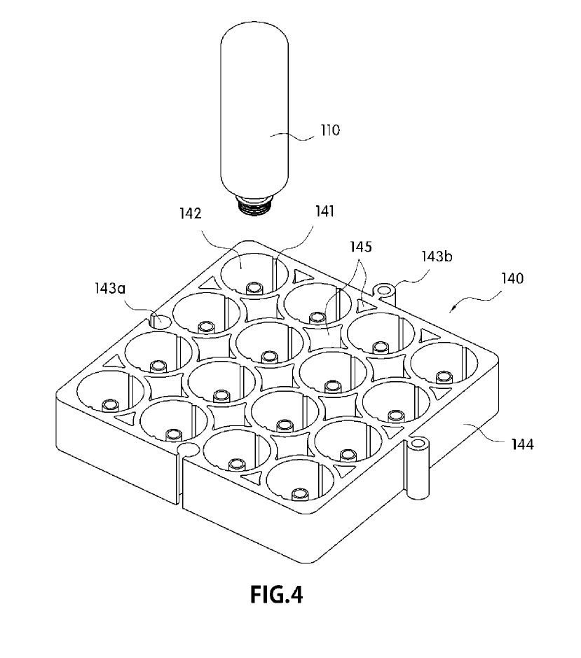

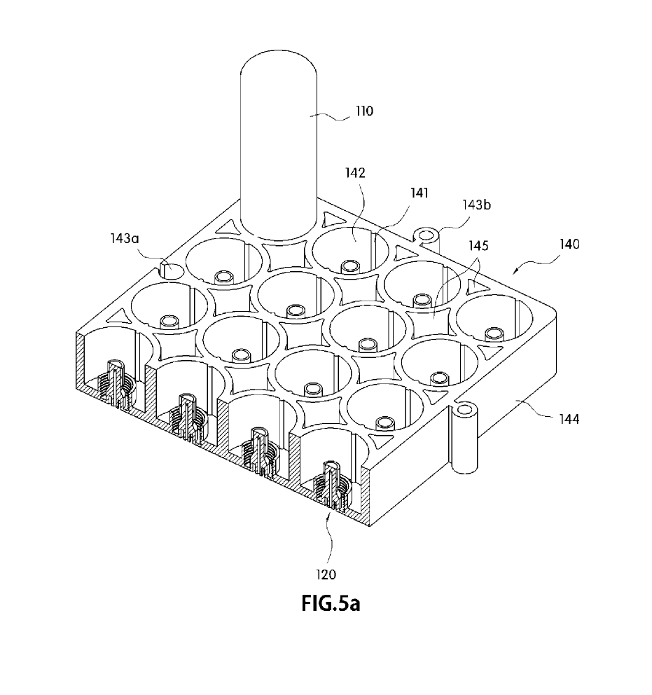

As illustrated in FIG. 4 to FIG. 5b, provided is an inlet-fixing connecting part 140 having a plurality of inlet stoppers 120 in a plurality of fixing recesses 142 into which a plurality of inlets 112 of the container 110 are fitted.

Specifically, the inlet-fixing connecting part 140 has the plurality of fixing recesses 142 depressed to a predetermined depth in the upper surface of a lower fixing member 144 such that the outer surfaces of the bodies of the containers 110 having the inlets 112 are fitted into and fixed by the plurality of fixing recesses 142. A plurality of inlet stoppers 120 is disposed on the bottom of the fixing recesses 142 such that the plurality of inlet stoppers 120 is connected to the plurality of inlets 112.

The lower fixing member 144 may be formed by extruding a resin material, such as plastic, like the fixing member 134 having the plurality of fixing holes 132 penetrating therethrough. At least one close-contact protrusion 141 is formed on the inner surface of each of the fixing recesses in order to increase fixing force through the increased close contact between the container 110 and the fixing recesses 142.

In addition, a coupling recess 143a and a coupling protrusion 143b are formed on the outer surface of the fixing member 144. The coupling recess 143a corresponds to and couples with a coupling protrusion protruding from the outer surface of an adjacent lower fixing member 144. The coupling protrusion 143b corresponds to and couples with a coupling recess depressed in the outer surface of an adjacent fixing member 144. A connecting hole penetrates through the coupling protrusion 143b such that a connecting member, such as a wire or a connecting cord, having a predetermined length can be connected thereto.

In addition, the fixing member 144 may have weight-reducing through-holes 145 formed between the adjacent fixing holes 142 in order to reduce the weight of the fixing member 144 and the amount of the material used, thereby reducing manufacturing costs.

With this configuration, the containers 110 having the inlets 112 are fitted into the fixing recesses 142 of the lower fixing member 144 such that the outer surfaces of the bodies of the containers are fixed. Simultaneously, the containers 110 are coupled with the inlet stoppers 120 provided in the fixing recesses 142. In this manner, the containers 110 can be fixed in position and assembled with the inlet stoppers 120 such that the air can be blown into the containers.

As illustrated in FIG. 5a, the inlet stoppers 120 are disposed integrally on the closed bottom of the fixing recesses 142. Alternatively, as illustrated in FIG. 5b, the inlet stoppers 120 are assembled to the stopper assembly holes 149 in a corresponding manner, the stopper assembly holes 149 penetrating through the closed bottom of the fixing recesses 142.

Each of the stopper assembly holes 149 may be assembled with each of the inlet stoppers in a screw coupling manner using female threads that mesh with male threads formed on the outer surface of the inlet stopper such that the inlet stopper can be attached to or detached from the stopper assembly hole. The stopper assembly hole 149 may be assembled integrally with the inlet stopper 120 by means of an adhesive applied on the inner surface thereof, or may be assembled integrally with the inlet stopper 120 by fusing an assembly boundary surface with high-temperature heat.

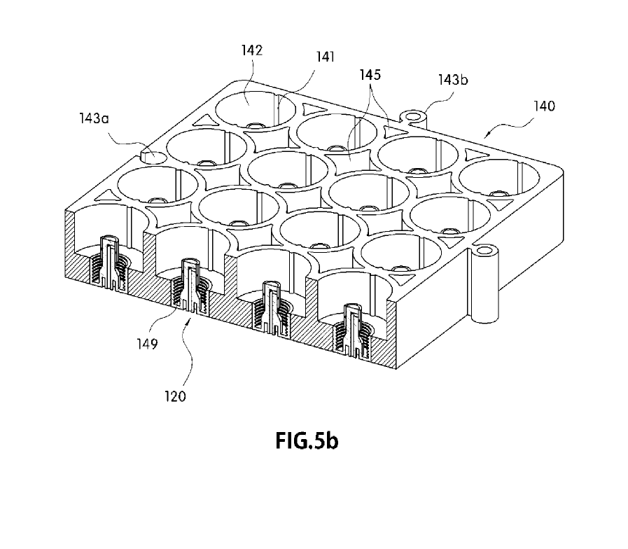

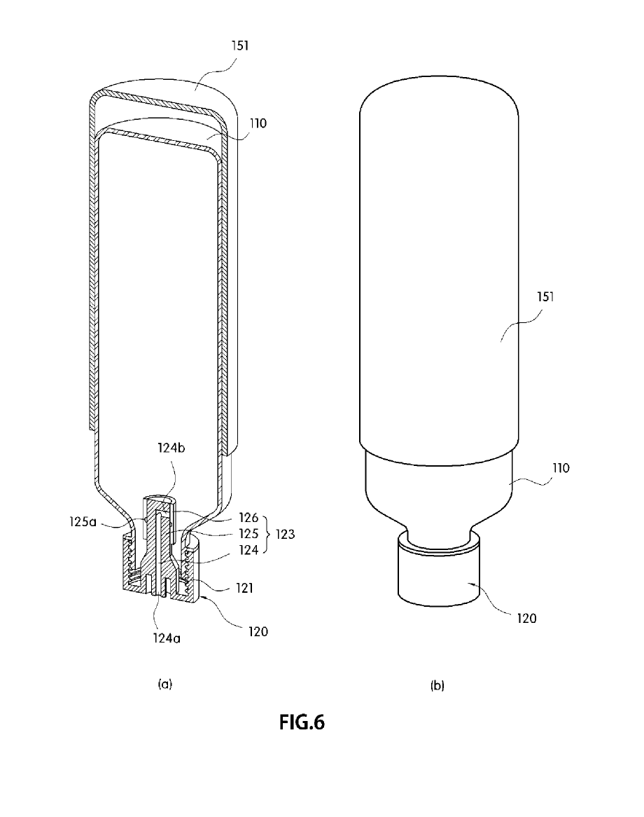

In the container 110, which couples with the inlet stopper 120 and becomes buoyant by the air contained therein, as illustrated in FIG. 6a and FIG. 6b, a first cover 151 has an open end portion corresponding to the inlet 112 and a closed end portion opposite the open end portion. The container 110 is fitted into the first cover 151 through the open end portion in a corresponding manner such that a majority of the container 110 is covered. With this configuration, when the volume of the container 110 expands in response to the air blown in through the stopper inlet 120, the outer surface of the container 110 becomes into close contact with the inner surface of the first cover 151. Accordingly, the container 110 can be protected from external environment when the container 110 is used as a buoyancy body.

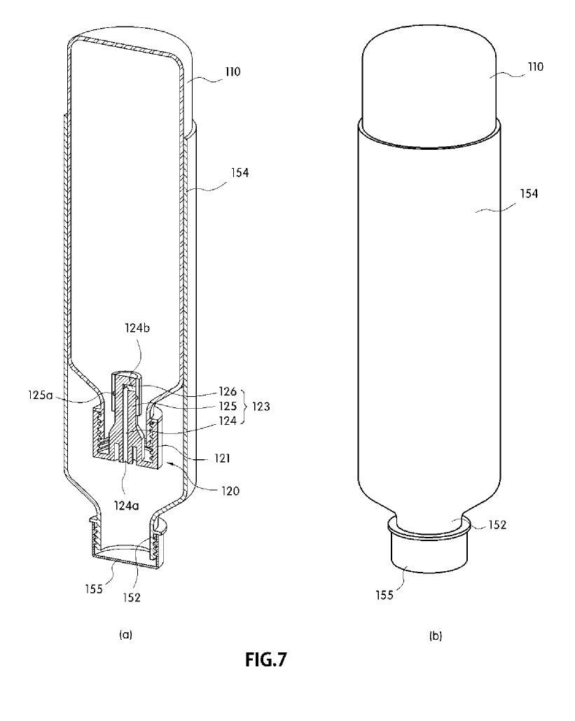

In addition, as illustrated in FIG. 7a and FIG. 7b, a second cover 154 is provided. A stopper 155 for opening and close a cover inlet 152 is provided on one end portion of the second cover 154 corresponding to the inlet 112. The other end of the second cover 154 corresponding to the closed end of the container 110 (the upper end with respect to the paper surface) is cut open such that the container 110 is fitted into the second cover 152 through the open end of the second cover 154 in a corresponding manner such that a majority of the container 110 is covered. When the stopper 155 assembled to the cover inlet 120 is opened and the air is blown through the exposed stopper inlet 120, the volume of the body of the container 110 expands such that the outer surface of the container 110 comes into close contact with the inner surface of the second cover 154. Accordingly, the container 110 can be protected from external environment when the container 110 is used as a buoyancy body.

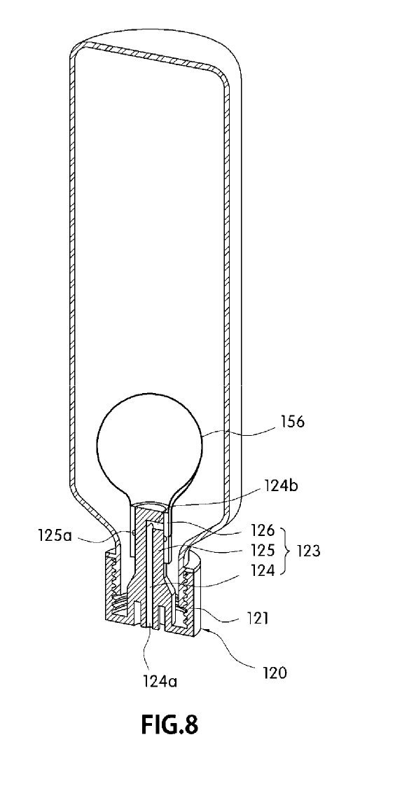

As illustrated in FIG. 8, the container 110 has an expansion member 156 disposed within the container 110, with an entrance end thereof being connected to the inlet stopper 120. The expansion member 156 is, for example, a rubber balloon, the volume of which expands when the air is blown in. When the air is blown into the container through the inlet stopper 120 in order to create buoyancy, the volume of the expansion member 156 expands within the inner space of the container 110 such that the outer surface of the expansion member 156 comes into close contact with the inner surface of the container 120, thereby preventing the air from leaking as much as possible.

Here, it is preferable that each of the first and second covers 151 and 154 be implemented as a different container, the cross-sectional shape of which is substantially the same as or similar to the cross-sectional shape of the container 110, such that the cover comes into close contact with the outer surface of the body.

In the floating assembly 100 configured as above, each container is fitted into the corresponding fixing hole 132 of the fixing member 134, and the inlet 112 of each container 110 is sealed by assembling the inlet stopper 120 thereto.

In this position, when the ambient air is blown through the air supply line 129 connected to the input terminal 124a of the input line 124 formed in the inlet stopper 120, the hollow elastic body 126 fitted on the outer surface of the valve body 125 to cover the nozzle terminal 124b of the input line exposed on the outer surface of the valve body 125 is partially raised and opened by the discharge pressure of the air that has been supplied through the input line by a predetermined input pressure. Consequently, the air is blown into the inner space of the container 110, expanding the volume of the container, such that the outer surface of the container comes into close contact with the inner surface of the fixing hole 132.

When the blowing of the ambient air through the input terminal 124a of the input line 124 is stopped, the nozzle terminal is covered and closed by the elastic restoration force of the hollow elastic body 126, thereby preventing the air from leaking in the reverse direction through the input line.

Consequently, when the air is blown into the plurality of containers fitted into the plurality of fixing holes in the fixing member 134, the outer surfaces of the containers fixedly come into close contact with the fixing holes as the volumes of the containers expand. At the same time, the containers become buoyant to float on the surface of the water due to the blown-in air.

Adjacent fixing members are integrally assembled to each other through the coupling between the coupling recesses and coupling protrusions formed on the outer surfaces thereof. The entire size of the assembled fixing members can be adjusted according to the designed size of the floating assembly.

A fluorescent material may be supplied together with the air contained in the inner space of the containers 110 or applied on the inner or outer surfaces of the containers 110. Accordingly, the position of the floating assembly 100 can be indicated at the night, and the floating assembly 100 can be easily located at a remote distance.

In addition, fluorescent bars formed of a fluorescent material may be fixedly disposed in the inlet stoppers 120 or fitted into the containers 110. The fluorescent bars allow the position of the floating assembly 100 to be indicated at the night and the floating assembly 100 to be easily located at a remote distance in the same manner as in the case in which the fluorescent material is supplied into the containers or is applied on the inner surfaces of the containers.

Furthermore, a separate location tracking device, such as a global positioning system (GPS) receiver, may be disposed in the inner space of at least one of the containers 110 in which the air is contained, whereby the floating assembly can be easily located during the day and night.

In addition, at least one light source that emits light in response to electricity applied thereto may be disposed in the inner space of at least one of the containers 110 in which the air is contained. The light source may be implemented as a lighting device using solar energy or a lighting device having a battery.

It should be understood that the present invention is not limited by the embodiments as set forth above and the drawings as attached. A person skilled in the art will appreciate that various substitutes, modifications, and changes are possible without departing from the scope and spirit of the invention.

1. A floating assembly comprising:
a plurality of containers, each of the plurality of containers being buoyant due to air contained in an inner space thereof through an inlet in one end thereof;
a plurality of inlet stoppers, each of the plurality of inlet stoppers sealing the inlet of a corresponding container of the plurality of containers using a check valve in a bottom of a stopper member that couples with the inlet, the check valve supplying air in a predetermined direction, thereby sealing the inlet; and
a container fixing part having a plurality of fixing holes into which the plurality of containers is fitted such that the plurality of containers is fixed in position, whereby the plurality of containers adjacent to each other is fixed.

2. The floating assembly according to claim 1, wherein the check valve comprises a valve body extending a predetermined length, the valve body having an input line through which the air is blown in, an input terminal of the input line being exposed on an outer surface of the stopper member, and a hollow elastic body fitted into the valve body, the hollow elastic body covering a nozzle terminal of the input line exposed on an outer surface of the valve body.

3. The floating assembly according to claim 2, wherein the input line comprises at least one linear hole penetrating in a longitudinal direction of the valve body.

4. The floating assembly according to claim 2, wherein the valve body comprises at least one protruding rim protruding from the outer surface of the valve body.

5. The floating assembly according to claim 2, wherein the hollow elastic body is fixed in position by a fixing ring that elastically adjoins an outer surface of the hollow elastic body.

6. The floating assembly according to claim 1, wherein the container fixing part comprises a fixing member in which the plurality of fixing holes is formed, wherein the plurality of containers are fixedly fitted into the plurality of fixing holes in a corresponding manner.

7. The floating assembly according to claim 6, wherein the fixing member comprises a coupling recess coupling with a coupling protrusion protruding from an outer surface of an adjacent fixing member in a corresponding manner and a coupling protrusion coupling with a coupling recess depressed in an outer surface of an adjacent fixing member in a corresponding manner.

8. The floating assembly according to claim 6, wherein the fixing member has weight-reducing through-holes each formed between adjacent fixing holes of the plurality of fixing holes.

9. The floating assembly according to claim 1, wherein each of the fixing holes has a close-contact protrusion protruding from an inner surface thereof, the close-contact protrusion adjoining an outer surface of a corresponding container of the plurality of containers.

10. The floating assembly according to claim 1, wherein the fixing member comprises an upper fixing plate having a plurality of upper fixing holes, a lower fixing plate having a plurality of lower fixing holes formed in areas corresponding to the upper fixing holes in a penetrating manner, and a connecting fixing plate connecting an outer circumference of the upper fixing plate and an outer circumference of the lower fixing plate to each other.

11. The floating assembly according to claim 1, wherein the container fixing part comprises an upper ring support having a plurality of circular or polygonal upper fixing rings, a lower ring support having a plurality of lower fixing rings in a plurality of areas corresponding to the plurality of upper fixing rings, and a connecting part connecting the upper and lower ring supports.

12. The floating assembly according to claim 1, further comprising an inlet-fixing connecting part into which predetermined end portions of the plurality of containers are fitted, the inlet-fixing connecting part comprising a lower fixing member, with a plurality of fixing recesses being depressed to a predetermined depth in an upper surface of the lower fixing member such that outer surfaces of bodies of the plurality of containers having the inlets are fitted into and fixed by the fixing recesses, inlet stoppers disposed on bottoms of the fixing recesses such that the inlet stoppers are connected to the inlets.

13. The floating assembly according to claim 12, wherein each of the fixing recesses has at least one close-contact protrusion protruding from an inner surface thereof, the close-contact protrusion adjoining an outer surface of a corresponding container of the plurality of containers.

14. The floating assembly according to claim 12, wherein the lower fixing member has a coupling recess coupling with a coupling protrusion protruding from an outer surface of an adjacent lower fixing member in a corresponding manner and a coupling protrusion coupling with a coupling recess depressed in an outer surface of an adjacent fixing member in a corresponding manner.

15. The floating assembly according to claim 12, wherein fixing member has weight-reducing through-holes each formed between adjacent fixing holes of the plurality of fixing holes.

16. The floating assembly according to claim 12, wherein the inlet stoppers are disposed integrally on closed bottoms of the fixing recesses or are assembled to the stopper assembly holes in a corresponding manner, the stopper assembly holes penetrating through the closed bottoms of the fixing recesses.

17. The floating assembly according to claim 1, wherein each of the plurality of containers comprises a first cover having an open end portion corresponding to the inlet and a closed end portion opposite the open end portion, the container being fitted into the first cover through the open end portion such that an outer surface of the container comes into close contact with an inner surface of the first cover.

18. The floating assembly according to claim 1, wherein each of the plurality of containers comprises a second cover, wherein a cover inlet formed in one end portion of the second cover corresponding to the inlet is opened and closed by a stopper, and the other end portion of the second cover corresponding to a closed end of the container is cut open, the container being fitted into the second cover such that an outer surface of the container comes into close contact with an inner surface of the second cover.

19. The floating assembly according to claim 1, wherein each of the plurality of containers comprises an expansion member having an entrance end connected to the inlet stopper, wherein, when air is blown in, a volume of the expansion member expands such that an outer surface of the expansion member comes into close contact with an inner surface of the container.

20. The floating assembly according to claim 1, wherein each of the plurality of containers comprises a fluorescent material supplied into an inner space thereof together with air, a fluorescent material applied on an inner or outer surface thereof, a location tracking device based on a global positioning system, or at least one light source disposed within the inner surface thereof.
